(19) United States
(12) Patent Application Publication
(10) Pub. No.: US 2006/0232515 A1
(43) Pub. Date: Oct. 19, 2006

(54) Method for driving a plasma display panel

(76) Inventors: Cédric Thebault, Oberestrasse 8, Lichtenberger Weg, 4, 78 (FR); Carlos Correa, Villingen-Schwenningen (DE); Sébastien Weitbruch, Niedereschach (DE)

Correspondence Address: THOMSON LICENSING INC., PATENT OPERATIONS, PO BOX 5312, PRINCETON, NJ, 08543-5312, US

(21) Appl. No.: 10/544,753

(22) PCT Filed: Dec. 23, 2003
(86) PCT No.: PCT/EP03/51094

§ 371 Date: May 4, 2006

(30) Foreign Application Priority Data
Feb. 24, 2003 (EP) 03003989.5

(51) Int. Cl. G09G 3/28

(52) U.S. Cl. 345/63

(57) ABSTRACT

The invention relates to a method for driving a display panel comprising a matrix array of cells which could be “ON” or “OFF”, wherein, to display an image, a video frame is divided into N sub-fields, each sub-field comprising at least an addressing period and a sustaining period, the addressing period being constituted either by a selective writing period or a selective erasing period and the duration of the sustaining period corresponding to the weight associated with said sub-field. According to the invention, the sub-fields successively alternate between a sub-field with a selective writing period and a sub-field with an erasing period. The invention is applicable to PDPs.

The present invention relates to a method for driving display panel using the principle of duty cycle modulation (P.W.M for pulse width modulation) of light emission.

### BACKGROUND OF THE INVENTION

The invention will be described in relation to plasma display panels (PDPs) but may be applicable to other types of displays using the same principle as the principle mentioned above.

As well known, plasma display panels (PDPs) used for image reproduction, such as for display of television images, are either of the AC type or of the DC type. In addition, a PDP may be of matrix or of coplanar type. For simplification purpose, a coplanar AC type PDP will be only described here. A PDP comprises a transparent front plate, to which is associated a first set of two parallel electrodes, and a back substrate, associated with a second set of parallel electrodes, perpendicular to the first set. The interval between the front and back plates is separated in cells containing a gas, for instance a mixture of Xenon and Neon, which, when selectively and properly excited by voltages applied to electrodes, produce ultraviolet (UV) light and this UV light excites phosphors deposited on walls of the cell and generate visible light. Due to this structure, a discharge cell could only be “ON” or “OFF”. Also, unlike other displays such as CRT (color ray tube) or LCD (liquid crystal display) in which gray levels are expressed by analog control of the light emission, a PDP controls the gray level by modulating the number of light pulses per frame. The light pulses are known as sustain pulses. This time modulation will be integrated by the eye over a period corresponding to the eye time response. Since the video amplitude is portrayed by the number of light pulses occurring at a given frequency, more amplitude means more light pulses and thus more “ON” time. For this reason, this kind of modulation is also known as PWM.

Different methods for addressing a plasma display panel are already known. In a classical way, a video frame is divided into N sub-fields during which the luminous elements can be activated for light emission in small pulses corresponding to a sub-field code, which is used for brightness control. Each sub-field comprises an addressing period for selecting the discharge cells and a lighting or sustain period for realizing the gray levels depending on the number of light pulses with, eventually an erasing or reset period for uniformly causing a discharge.

In fact, the PDP driving methods are mainly classified into selective writing methods and selective erasing methods depending on an emission of the discharge cell selected by the address discharge.

In a classical selective writing method, the control of the PDP is in the following way:

At the beginning of each field is realized a priming of the cells to generate charges on the walls of all the cells. In this case, the cells already presenting charges do not change of state and the cells having no charge accumulate charges. Afterwards, all the cells are erased in order to eliminate these wall charges. This succession of operations is necessary to eliminate the wall charges. In fact, if the priming did not take place before the erasing, cells presenting no charge would accumulate wall charges during erasing. After erasing, the cells, which must emit light are addressed. During the addressing or writing period, charges are created on the walls of the selected cells. After the addressing period, a sustain voltage is applied to addressed cells. The cells emit useful light only during this sustain period. So during the priming and erasing periods, all cells emit light. This light is undesirable for the cells, which are not selected. This explains the relatively poor contrast obtained with PDPs.

A selective wring method as described above is shown in FIG. 1. In this case, the 255 levels per color are obtained using a combination of the 8 following bits:
1-2-4-8-16-32-64-128

To realize such coding, the frame period is divided in 8 sub-fields, each corresponding to a bit. The number of light pulses for the bit “2” is the double as for the bit “1” and so on. With these 8 sub periods, it is possible through combination to build the 256 gray levels. The eye will integrate over a frame period these sub periods to catch the right gray level. In this case, as shown in FIG. 1, all the sub-fields are selectively write and after the sustain period fully erased. More specifically, each sub-field comprises a priming period, a writing period, a sustain period and an erasing period, the priming, writing and erasing periods having the same duration for each sub-field. In this figure, only the blocks corresponding to a sustain period will provide light; the rest of the time is wasted. This wasted time is the same from one sub-field to another. In fact, the operation the most costly in term of time is the selective operation.

In a first selective erase method, the control of the PDP is realized in the following way: In this case, all the cells of the panel are firstly written using, for example, a hard priming. Then, the cells that should not be “ON” are selectively erased. Afterwards, the sustain operation is applied on all cells. Only the cells not erased will produce lighting pulses. There will not be a gas discharge in the cells in neutral state. Such method is shown in FIG. 2. So, for each sub-field, there will be a priming period, an erasing period and a sustain period, the duration of the priming and erasing periods being constant for each sub field. The only advantage of this method is the saving of time with the same flexibility as the selective write method. However, with this selective erase method, a black pixel needs a selective erase for all sub fields. In addition, the use of priming produces light and the selective erase produces noisy light, so their use can reduce the quality of the black level and the on ratio.

Another selective erased method is the concept developed by Pioneer and known as “CLEAR”. So, at the beginning of the frame, a priming operation will excite all the cells. Then, a selective erasing operation will be performed. During the next sustaining operation, only the cells which have not been erased before, will lighten.

In order to remedy the above defects, combinations of both selective writing and selective erasing methods have been proposed. For example, in the European patent application EP 1 172 794 A2 filed in the name of LG Electronics Inc, it is proposed a method for driving a plasma display panel at a high speed with an improved contrast. In this method, at least one selective writing sub-field is used to turn on discharge cells selected in an address interval and at least one selective erasing sub-field is used to turn off the discharge cells selected in the address interval. The selective writing sub-field and the selective erasing sub-field are arranged within one frame. More specifically, one selective writing operation is done on the first sub-fields followed by a selective erasing operation done on the last sub-fields of a frame. According to a specific embodiment, the selective writing and selective erasing operations may be periodically alternate, the selective erasing being done on several consecutive sub-fields. This method give less flexibility for encoding.

### SUMMARY OF THE INVENTION

The invention proposes improvements to the method described in the above application.

The invention relates to a method for driving a display panel comprising a matrix array of cells which could be “ON” or “OFF”, wherein, to display an image, a video frame is divided into N sub-fields, each sub-field comprising at least an addressing period and a sustaining period, the addressing period being constituted either by a selective writing period or a selective erasing period and the duration of the sustaining period corresponding to the weight associated with the said sub-field, characterized in that the sub-fields are successively alternate between a sub-field with a selective writing period and a sub-field with an erasing period, a sub-field with a selective erasing period following a sub-field with a selective writing period, at least one of the first sub-fields being sub-fields with a selective writing period.

According to an other feature of the present invention, the weights of the sub-fields are such that a given sub-field amongst the N sub-fields has never a higher weight than the sum of the 2 previous sub-field weights. A code with this properly is also referred as Fibonacci sub-field code.

According to one embodiment the weights of the sub-field respect the following rules:

If the i^{th} sub-field uses selective write, its weight should be interior to the sum of the weights of the previous sub-fields plus 1

If the i^{th} sub-field uses selective erase, its weight should be inferior to the sum of the weights of the previous sub-fields plus 1 minus the previous sub-field.

According to an other embodiment of the present invention, the N sub-fields are shared in two groups, a first group with the sub-fields of low weight and a second group with the sub-fields of high weight each sub-field of the first group being combined with a sub-field of the second group, the first sub-field of the combination having a selective write period while the second sub-field of the combination has a selective erase period. In this case, within each group, the weight order may strictly increase. However, to improve the behavior of the panel concerning, for example, the flicker or false contour, the weight order may be different.

### BRIEF DESCRIPTION OF THE DRAWINGS

The present invention will be explained hereafter in more detail with reference to the following description and the drawings wherein:

FIG. 1 already described, shows an example of a sub-fields organization according to prior art in case of sub-fields with selective writing period,

FIG. 2 already described, shows an example of a sub-fields organization with selective period,

FIG. 3 shows an example of a sub-fields organization according to a first embodiment of the present invention,

FIG. 4 shows an example of a sub-fields organization according to a variant of the embodiment of FIG. 3.

FIG. 5 shows an example of a sub-fields organization according to a second embodiment of the present invention.

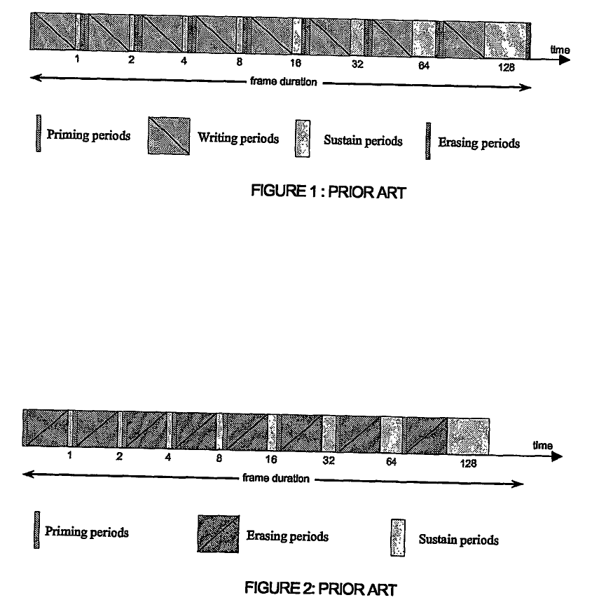

### DESCRIPTION OF PREFERRED EMBODIMENTS

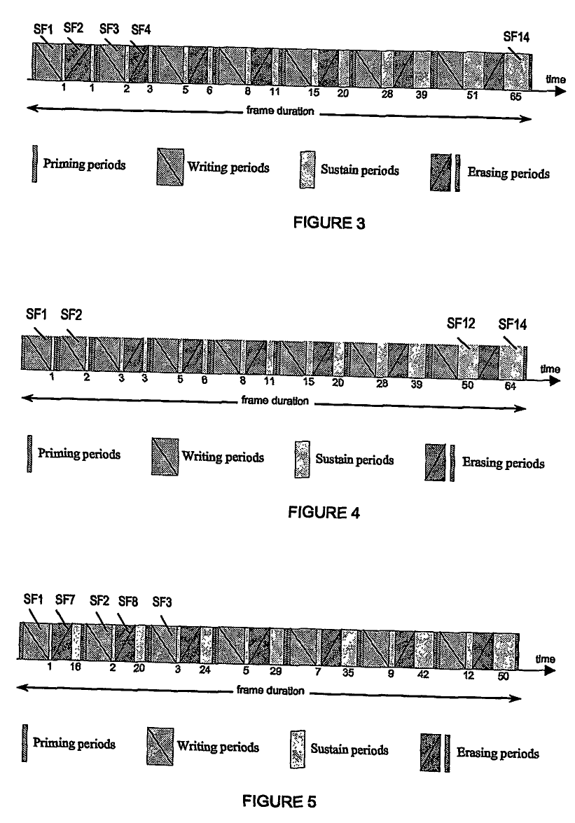

On FIG. 3, a sub-field organization with 14 sub-fields SF1 to SF14 is presented. The weights of the sub-fields are as follows:
1-1-2-3-5-6-8-11-15-20-28-39-51-65

The specific weight in said sub-fields SFi (1≦i≦14) represents a subdivision of the 256 video levels to be rendered in 8 bits video mode. Then, each video level from 0 to 255 will be rendered by a combination of those sub-fields, each sub-field being either fully activated or deactivated. FIG. 3 illustrates a frame period that is, for example, of 16.6 ms for 60 Hz frame period and its sub-division in sub-fields SF. According to the present invention, the sub-fields used during this period are of two types and are alternate. More specifically, the odd sub-fields SF1, SF3, SF5 . . . SF11, SF13 are sub-fields with a selective writing period. So, as shown on the figure, each sub-field is a period of time in which successively the following is being done with a cell:

1. There is a priming period wherein all the cells are excited to reduce the inertia of the cells.

2. There is a selective writing period wherein only the cells that should be activated receive selectively a first discharge. The other cells are brought to a neutral state. These two periods are of fixed duration.

3. There is a sustain period depending on the sub-field weighting in which a gas discharge is made with short voltage pulses which lead to corresponding short lighting pulses. In this case, only the cells previously excited will produce lighting pulses.

The even sub-fields SF2, SF4, SF6 . . . SF12, SF14 are sub-fields with a selective erasing period. They follow immediately a sub-field with a selective writing period. As shown in FIG. 3, each sub-field is a period of time in which successively the following is being done with a cell:

1. There is a selective erasing period wherein the charges in the written or addressed cells are selectively removed. If no erase signal is applied to a cell, it will keep its charges.

2. There is a sustain period depending on the sub-field weighting in which a gas discharge is made as described above in relation with sub-fields with a selective write period.

Moreover, in this specific sub-field organization, the weights of the sub-fields are based on the mathematical Fibonacci sequence as described in PCT patent application No. WO 01/56003. This optimized sub-fields encoding enables to have no more than one sub-field OFF between two sub-fields ON (SOL concept). However, it is clear for the man skilled in the art that the invention is also applicable when the coding of the weights is not based on this specific sequence. So for the above sub-field organization, the 256 levels have the following code words: For clarity, only some of them are given hereafter and the sub-fields with a selective erase period are in bold while the sub-fields with a selective write and mandatory for the activation of the next sub-field with a selective erase period are underlined.

| | |
|---|---|
| level 0 Coded in 0 0 0 0 0 0 0 0 0 0 0 0 0 0 | level 137 Coded in 0 0 1 1 1 1 0 1 1 1 1 1 1 0 |
| level 1 Coded in 1 0 0 0 0 0 0 0 0 0 0 0 0 0 | ---------------------------------------------- |
| level 2 Coded in 1 1 0 0 0 0 0 0 0 0 0 0 0 0 | |
| level 3 Coded in 1 0 1 0 0 0 0 0 0 0 0 0 0 0 | |
| level 4 Coded in 1 1 1 0 0 0 0 0 0 0 0 0 0 0 | |
| --------------------------------------------- | |
| level 15 Coded in 1 1 1 0 1 1 0 0 0 0 0 0 0 | |
| level 16 Coded in 0 0 1 1 1 1 0 0 0 0 0 0 0 0 | level 253 Coded in 0 0 1 1 1 1 1 1 1 1 1 1 1 1 |
| level 17 Coded in 1 0 1 1 1 1 0 0 0 0 0 0 0 0 | level 254 Coded in 1 0 1 1 1 1 1 1 1 1 1 1 1 1 |
| level 18 Coded in 1 1 1 1 1 1 0 0 0 0 0 0 0 0 | level 255 Coded in 1 1 1 1 1 1 1 1 1 1 1 1 1 1 |

So as seen above, with this organization, it is only possible to have 00, 10, 11.

In fact, this organization offers more flexibility for the encoding than the solution already described. In this case, the sub-fields using a selective erase period can only be used, i.e. activated, when the previous sub field is activated.

On FIG. 4, a variant of the sub-field organization with 14 sub-fields is presented. In this case, the weights of the sub-fields are the following:
1-2-3-3-5-6-8-11-15-20-28-39-50-64;

According to the invention, in this variant some of the first sub-fields are only sub-fields with a selective write period. More specifically, the three first sub-fields SF1, SF2, SF3 are sub-fields with a selective write period. For the following sub-fields, they are alternate as mentioned above. So, the even sub-fields SF4, SF6 . . . SF12, SF14 are sub-fields with a selective erase period and the other odd sub-fields are sub-fields with a selective write period. So for the above sub-field organization, the 256 levels have the following code words: For clarity, only some of them are given hereafter and the sub-fields with a selective erase period are in bold while the sub-fields with a selective write and mandatory for the activation of the next sub-field with a selective erase period are underlined.

level 0 Coded in 0 0 0 0 0 0 0 0 0 0 0 0 0 0
level 1 Coded in 1 0 0 0 0 0 0 0 0 0 0 0 0 0
level 2 Coded in 0 1 0 0 0 0 0 0 0 0 0 0 0 0
level 3 Coded in 1 1 0 0 0 0 0 0 0 0 0 0 0 0
level 4 Coded in 1 0 1 0 0 0 0 0 0 0 0 0 0 0
level 5 Coded in 0 1 1 0 0 0 0 0 0 0 0 0 0 0
---------------------------------------------
level 253 Coded in 1 0 1 1 1 1 1 1 1 1 1 1 1 1
level 254 Coded in 0 1 1 1 1 1 1 1 1 1 1 1 1 1
level 255 Coded in 1 1 1 1 1 1 1 1 1 1 1 1 1 1

So in this embodiment, it is possible to have 00, 10, 11.

According to the present invention, in a more general way, if all the levels have to be achieved, the weights of the sub-fields have to respect two rules:
If the i^{th} sub-field uses selective write, its weight should be inferior to the sum of the weights of the previous sub-fields plus 1. For example, in the above embodiment:
   W₅(5)≦W₁+W₂+W₃+W₄+1(1+2+3+3+1=10)
If the i^{th} sub-field uses selective erase, its weight should be inferior to the sum of the weights of the previous sub-fields plus 1 minus the previous sub-field (using selective write). For example, in the above embodiment
   W₆(6)≦W₁+W₂+W₃+W₄+1(1+2+3+3+1=10)
   W₈(11)≦W₁+W₂+W₃+W₄+W₅+W₆+1 (1+2+3+3+5+6+1=21).

These first embodiments of the invention, gives a better behaviour concerning false contour. With the 14 sub-fields code presented above, the same quality as with a 12 sub-fields code using only sub-fields with a selective write period can be achieved. If the selective erase period is fast enough, these two codes are equivalent in terms of time but the number of priming used in this case is lower, so the contrast is higher.

An other embodiment of the present invention will be described with reference to FIG. 5. In this case, the 14 sub-fields are shared in two groups, a first group of 7 sub-fields with the sub-fields of low weight and a second group of 7 sub-fields with the sub-fields of high weight, each sub-field of the first group being combined with a sub-field of the second group, the first sub-field of the combination having a selective write period while the second sub-field of the combination has a selective erase period.

Taking, for example, a growing code with 14 sub-fields such as:
1-2-3-5-7-9-12-16-20-24-29-35-42-50

This code being a Fibonacci code, the sub-fields are shared in two groups, a first one with the sub-fields of low weights 1-2-3-5-7-9-12-16 and the sub-fields of high weights 20-24-29-35-42-50. Then, the ith (with 1≦i≦7) sub-field is combined with the (7+ith) sub-field to obtain the following groups as shown in FIG. 5:
1-16, 2-20, 3-24, 5-29, 7-35, 9-42, 12-50,

The first sub-field of each combination is a sub-field with a selective write period and the second sub-field is a sub-field with a selective erase period.

According to the present invention, the combination can be done using different orders that the order described above in order to improve the behavior concerning, for example, the flicker or the false contour.

On FIG. 5 is represented the easiest way to realize the present invention. In this case, the sub-fields are arranged by growing weights. It is also possible to use an other order for the combinations such as, for example, 1-16, 3-24, 7-35, 12-50, 2-20, 5-29, 9-42. This order has the advantage to generate fewer flickers.

In the embodiment of FIG. 5, the low levels (from 0 to 39; since 39 is the sum of the n smallest sub-fields 1+2+3+5+7+9+12=39) will use only the sub-fields with a selective write period, so these levels will have the whole flexibility to be encoded because any of these sub-fields can be switched on or off independently. For the higher levels, the higher sub-fields will be required, and it will no longer be possible to use independently the small sub-fields. For example, when the sub-field with weight 16 is used (this will be only the case of video levels bigger than 39), the sub-field with weight 1 has to be on, but this is not so important since it is not necessary to have the flexibility to use it since a difference of 1 for the video levels bigger than 39 is not very relevant; some levels can miss, it will not make a difference since the difference between the used levels will be low in percentage.

The same limitation will occur for the other small sub-fields; for example when the sub-field with weight 35 is used, the sub-field with weight 7 has to be on, but as said previously the lost of flexibility is not so important since the difference between the rendered levels will always be low in percentage. The worst case is for the higher levels where there is no rendered video level between 239 (255−16, since 16 is the weight of the smallest sub-field which can be used independently) and 255, but this lack of level, which is partly compensated by using dithering, will not be perceptible because of the human visual system luminance sensitivity (Weber-Fechner law); actually the difference in percentage in this case is only 6% (16/255=6%).

Some examples of encoded video levels (other encoding are possible) in the case of the organization represented in FIG. 5 are as follow:

Level 16: 1 0 0 0 1 0 1 0 1 0 0 0 0 0
---------------------------------------
Level 39: 1 0 1 0 1 0 1 0 1 0 1 0 1 0
Level 40: 1 1 1 0 0 0 1 0 1 0 1 0 0 0
---------------------------------------
Level 80: 1 1 1 1 1 1 0 0 1 0 1 0 0 0
---------------------------------------
Level 141: 1 1 0 0 1 1 1 1 1 1 1 0 1 0
---------------------------------------
Level 239: 1 0 1 1 1 1 1 1 1 1 1 1 1 1

Since all video levels will not be available for the encoding (at least all levels between 239 and 255), a rescaling and a mapping as described in the EP patent application 1256924A1, have to be applied to the picture.

The main advantage of this specific embodiment of the invention is the full flexibility for the low levels, and the alternative flexibility for the high levels compared to the one presented in the two first embodiments.

Another advantage of this present embodiment is the reduction of the number of sub-fields with a selective addressing operation. So if the selective erase operation is faster than the selective write operation, some time is saved and can be better used to increase the number of sustains and so the brightness and the contrast.

The embodiments described above can be modified without departing from the scope of the claims.

1. A method for driving a display panel comprising a matrix array of cells which could be “ON” or “OFF”, wherein, to display an image, a video frame is divided into N sub-fields, each sub-field comprising at least an addressing period and a sustaining period, the addressing period being constituted either by a selective writing period or a selective erasing period and the duration of the sustaining period corresponding to the weight associated with the said sub-field, and wherein the frame comprises sub-fields with a selective writing period and sub-fields with a selective erasing period, each of said sub-field with a selective erasing period following a sub-field with a selective writing period.

2. A method according to claim 1, wherein the first sub-fields of the frame are sub-fields with a selective writing period.

3. A method according to claim 1, wherein the sub-fields of the frame are successively alternate between a sub-field with a selective writing period and a sub-field with a selective erasing period.

4. A method according to claim 1, wherein the weights of the sub-fields are such that a given sub-field amongst the N sub-fields has never a higher weight than the sum of the 2 previous sub-field weights.

5. A method according to claim 4, wherein the weights of the sub-fields are increasing within one frame and respect the following rules:
if the i^{th} sub-field uses selective write, its weight should be inferior to the sum of the weights of the previous sub-fields plus 1
if the i^{th} sub-field uses selective erase, its weight should be inferior to the sum of the weights of the previous sub-fields plus 1 minus the previous sub-field.

6. A method according to claim 4, wherein the N sub-fields are shared in two groups, a first group with the sub-fields of low weight and a second group with the sub-fields of high weight, each sub-field of the first group being combined with a sub-field of the second group, the first sub-field of the combination having a selective writing period while the second sub-field of the combination has a selective erasing period.

7. A method according to claim 6, wherein within each group, the weight order is strictly increasing.
